(19) United States
(12) Patent Application Publication
(10) Pub. No.: US 2009/0204905 A1
(43) Pub. Date: Aug. 13, 2009

(54) Wide Area Interactive Information Distribution System

(76) Inventor: Kenneth C.P. Toghia, Santa Ana, CA (US)

Correspondence Address: Thomas L. Peterson, Suite 703, 1233 20th Street, Washington, DC, 20036, US

(21) Appl. No.: 12/028,647

(22) Filed: Feb. 8, 2008

(51) Int. Cl. G06F 3/048; G06F 15/16

(52) U.S. Cl. 715/753

(57) ABSTRACT

A wide area interactive information distribution system having a webserver that distributes information to a plurality of users having mobile display devices. The webserver and mobile devices allows users to interact with each other.

### BACKGROUND OF THE INVENTION

The present invention generally relates to the field of information distribution and more particularly, is directed to a wide area interactive information distribution system which allows a large number of people to interact electronically between themselves and with an information provider.

The present invention has particular application in places such as theme parks, large sporting venues and the like where large numbers of visitors meet to watch or participate in activities. In gatherings of this type, it is important to keep visitors informed of developments that affect their visit and to provide them with relevant information regarding their visit, such as wait times, new attractions, etc. It is also important to make the visit as enjoyable as possible, including keeping the visitor entertained and occupied between the activities for which the visitor came. In many cases, a visitor might wish to share his or her experience with family members and friends during or after the visit. The present invention accomplishes all of these tasks as well as provide other important advantages.

### SUMMARY OF THE INVENTION

In a preferred embodiment, the present invention is implemented as a mobile social network and interactive theme park information and entertainment system. Note, however, that the invention is not limited to a theme park environment and may be used anywhere there is a need to keep people informed and to allow them to interact with each other electronically.

The invention can be used to change the way people experience and interact with other users in their favorite theme park. The invention allows users to connect with each other and the information they want anywhere at anytime. Also provided by the present invention are online games that will keep users entertained and exploring theme parks in new and unique ways.

The inventors have discovered that that timely interactive content is the key to keeping users engaged and active. The present invention is designed to unchain users and give them access to a vast variety of interactive systems, both at home and on their mobile devices. In accordance with the present invention, visitors at home will have an around the clock portal to connect with their friends and their favorite theme park, and mobile users will have the advantage of access to up-to-the-minute condition information and a wide variety of interactive entertainment options.

Social networking sites provide an online identity for their users, and the present invention expands access to that social interaction beyond the conventional desktop limits. By providing innovative interactive tools, the present invention simplifies the process of personal content creation which will keep social communities growing and evolving rapidly. In accordance with the present invention, users will be able to share their information and experiences while they are still happening. This is the logical next step in the evolution of social networking systems.

In the online interactive gaming mode, the present invention keeps users entertained and challenged with a variety of offerings, including everything from location relevant, multi-player trivia challenges, to role playing interactive mobile quests. The system provides offerings for both children and adults that will keep them playing and competing against each other while they are at home in front of their desktop, or in line waiting for their favorite ride at an amusement park or other gathering venu.

In the theme park travel mode (as used in a theme park environment), the present invention replaces existing park maps, guide books and online information sites with interactive and adaptive tools that travel with users and keep them ahead of changing conditions. Frequent visitors will have the ability to make quick decisions about shows and attractions they want to visit next, and one time visitors will be able to take advantage of forecasting tools to plan and modify interactive tour agendas.

Social networking is the new standard for the average person's Internet identity creation. Systems such as MySpace.com now number members in the hundreds of millions and where marketers were initially afraid to place ads on user created content, the spending on social network advertising is expected to reach $2.5 billion by 2010. (Source: eMarketer, November 2006) In just 2007 alone MySpace is expected to make more than $525 Million dollars in ad revenue and more than $45 Million is expected to be made by “niche” social networking sites. (Source: zNet.com November 2006) The inventors have discovered that a mobile solution in accordance with the present invention is the most effective way to keep social network users engaged and online.

For most theme parks, visitor information about ride times, fast pass availability, crowd conditions, and special events are only available at each particular attraction. Presently, most news about the theme parks is distributed through internet websites that are visited while the users are still at home. The greatest source of theme park travel planning information remains in traditionally published guide books. These sources of information are static and cannot reflect changing conditions or require that the user actually be at the attraction to observe conditions.

Independently of theme parks, large and very active online social groups have been established, but these resources have limited scope, availability, and reliability for most visitors. The information and interaction needs of these communities have grown beyond the limits of standard broadband social networking and require tools and technology that keep them informed, entertained, and connected both inside and outside a theme park environment.

According to ThemeParkInsider.com, the top 10 domestic theme parks with associated attendance for the year 2006 were as follows:
Walt Disney World's Magic Kingdom, 16.64 million
Disneyland, Anaheim, 14.73 million
Epcot, 10.46 million
Disney-MGM Studios, 9.10 million
Disney's Animal Kingdom, 8.91 million
Universal Studios Florida, 6.00 million
Disney's California Adventure, 5.95 million
SeaWorld Orlando, 5.74 million
Universal's Islands of Adventure, 5.30 million
Universal Studios Hollywood, 4.70 million

The novel features of the present invention are set out with particularity in the following detailed description of the preferred embodiment. But the invention will be understood more fully and clearly from the detailed description of the invention as set forth in the accompanying drawing in which:

### BRIEF DESCRIPTION OF THE DRAWING

FIG. 1 illustrates an overall system view of the present invention.

### BRIEF DESCRIPTION OF THE PREFERRED EMBODIMENT

The present invention is a new concept for mobile and desktop internet based community building. Utilizing the solid foundation of the SocialURL social networking platform, the system of the present invention integrates off the shelf chat, SMS, MMS solutions with custom mobile application code. The system will allow theme park visitors for the first time to receive detailed up to the minute information about the conditions of the theme park they are visiting, play interactive games with other users, and document their theme park experience for others to view, all while they are in the process of experiencing the theme park. The system delivers this interactivity in the form of two interconnected systems.

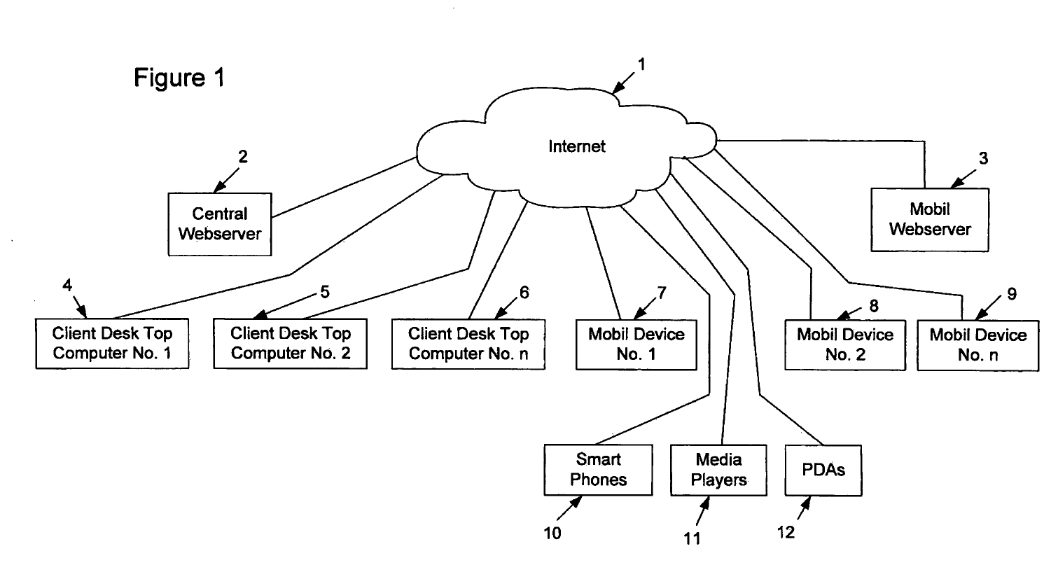

The interconnected systems are illustrated in FIG. 1 which shows a cloud 1 representing the Internet, Central Webserver 2; Mobile Webserver 3; a plurality of Client Desk Top Computers 4, 5, and n; a plurality of Mobil Devices 7, 8 and n; Smart Phones 10; Media Players 11 and PDAs 12.

A central website will serve as the Desktop Portal to the system. The central website is hosted on Central Webserver 2 as illustrated in FIG. 1. Visitors to this site will be able to create a personal profile for others to visit. They will be able to easily create picture and video blogs about their theme park visits for others to enjoy. They will be able to meet new users and interact with them via buddy list enabled chat or private message. They will also have a variety of tools available to help them configure their Mobile experience with the system of the invention, including options that will allow them to choose what type of information they want pushed to their cellular phones, how visible they will be to other users while they are inside the theme parks, and even have the ability to track and display when and how often they have experienced their favorite attractions. A person of ordinary skill in the art will be able the created and implement the all of the tools needed to achieve the above.

A second website will serve as the Mobile Portal to the system and is hosted on Mobil Webserver 3 as illustrated in FIG. 1. Mobil Webserver 3 supports a plurality of mobile display devices as illustrated in FIG. 1, includes smart phones, media players and PDAs.

Users will be able to log into the system inside or outside the park and retrieve critical information about wait times, and crowd conditions for a variety of different attractions and shows. Users will also be able to register when they are inside the theme park, which will allow them to play special interactive games, and allow other visitors to contact and even meet them in person. Users will also be able to upload a variety of information, images, and even video to the desktop portal for use on their profiles.

Development and deployment of a system in accordance with the present invention is most efficiently done in three distinct phases. Phase one is designed to attract the existing adult online theme park enthusiast and will introduce a basic social networking, information, and multiplayer gaming experience. Phase II safely extends our social networking tools for children and promotes the establishment of smaller subset communities. It is also in this second development phase that we plan to introduce more complex multiplayer gaming. Phase III allows us to harvest the statistical information our system has been collecting and helps us develop sophisticated crowd forecasting and travel planning tools.

More specifically, the first phase is intended to launch the basic profile, entertainment, and interactive models while creating a foundation for the development of more robust systems targeted towards specialized users. This phase includes the following:
Profile—The online home of users, a place to share trip experiences, personal photos, video, and theme park achievements
Buddy List—A place for users to keep track of their friends and family and quickly initiate a chat session with them or send them a private message
Picture Gallery—The online photo album of users for private or personal viewing
Member Guest Book—A place for visitors to leave comments on a users profile
Video Gallery—A Place for users to link video from external sources for visitors to enjoy
Trip Report Builder—A new way for users to quickly build blog entries utilizing information updated from the mobile system
Push Alert Configuration—How users configure when special condition alerts are sent to their cell phones; a way for users to define important events, store reservations and configure mobile reminders
Private Messaging—The internal email system for the site users
Private chat and chat rooms—For users to interact on the system

The Mobile Phase I features in accordance with the present invention include:
Ride Wait Times and Available Fast Pass Times—Information delivered on current conditions inside the theme park
Show Schedules and Crowd (Scheduled Event) Reports—For parades and shows within the parks
Fast Pass Tracker—An interactive way for users to keep track of their fast passes and when new passes are available
Status Map—A graphical representation of conditions within the parks
Trivia Game Show—A Multi-Player interactive trivia challenge played with users at home and in the theme parks
Trivia Challenge—Single Player location-based online trivia game
Image Upload—A way for users to upload camera phone images from the theme park to their profile page
Hot Tip!—A system allowing users to post up-to-the-minute news to online and in-park users
Push Alert Configuration—A way for users to view and update their event and reservation reminders inside the park
Ride Tracker—A system for logging when users experience their favorite attractions
Private Messaging—Users interacting online and in-park
Mobile Chat—The Buddy list enabled mobile chat system for our users
Help request—a method for our users to obtain chat based or in-park assistance from our staff

Phase II of development focuses on new mobile entertainment platform, group development, and family friendly systems. This phase includes:
Enhancements to allow family-safe, parental-controlled social interaction and game play by children, tweens, and teens.
The introduction of several interactive game systems designed to allow players at home and in park to connect and compete with each other.
New to the Neighborhood—A listing of new users close in proximity that have joined the site recently.
Buddy Meeting Requests—A method for users to set up meetings with other users

Phase III of development focuses on the development of condition forecasting tools and creation of the worlds first interactive theme park travel guide. This phase includes:
Virtual tour guide—An interactive agenda planner that adapts to changing conditions, and user desires to create optimized park visits.
Time to travel condition forecasting—Allowing users to better prepare their travel plans.
Parkipedia—An extensive online park information resource including text, audio, video, and interactive media that, when coupled with our real-time condition monitoring, will become the ultimate up to the minute accurate theme park guide.
Travel, dining, and entertainment reservation system—Our users mobile travel agent and digital concierge.

It should be obvious from the above-discussed embodiment of the present invention that numerous other variations and modifications of the invention are possible, and such will readily occur to those skilled in the art. Accordingly, the scope of this invention is not to be limited to the embodiment disclosed, but is to include any such embodiments as may be encompassed within the scope of the above described preferred embodiment.

We claim:

1. A wide areas interactive information distribution system, said system comprising:
at least one webserver for distributing information;
a plurality of mobile display devices adaptable for connecting to said webserver;
wherein said plurality of mobile display devices and said webserver allows users of said plurality of mobile display devices to interact between themselves
